(19) United States
(12) Patent Application Publication
(10) Pub. No.: US 2019/0236945 A1
(43) Pub. Date: Aug. 1, 2019

(54) Vehicle Alarm System, Alarm Device and Alarm Method Thereof

(71) Applicant: Compal Electronics, Inc., Taipei City (TW)

(72) Inventors: BO-XUN YE, Taipei City (TW); CHIA-YUAN LIN, Taipei City (TW); CHIH-HAO LEE, Taipei City (TW)

(21) Appl. No.: 16/251,046

(22) Filed: Jan. 17, 2019

Related U.S. Application Data
(60) Provisional application No. 62/619,065, filed on Jan. 18, 2018.

(51) Int. Cl. G08G 1/0965; B60Q 9/00; G08G 1/09

(52) U.S. Cl. CPC G08G 1/0965; G08G 1/091; B60Q 9/00

(57) ABSTRACT

A vehicle alarm system includes at least one alarm transmitting device and at least one alarm receiving device. Each alarm transmitting device is disposed in at least one first vehicle. The alarm transmitting device includes a satellite positioning system. The alarm transmitting device of the first vehicle generates an alarm signal and wirelessly transmits an alarm signal. The alarm signal includes a destination signal and a vehicle coordinate signal. The satellite positioning system generates the vehicle coordinate signal. The destination signal includes a coordinate of a destination. The first vehicle moves toward the destination. Each alarm receiving device is disposed in a second vehicle. The alarm receiving device of the second vehicle receives the alarm signal wirelessly. The alarm receiving device generates an alert signal according to the alarm signal.

### FIELD OF THE INVENTION

The present invention relates to an alarm system, an alarm device and an alarm method, and more particularly to an alarm system, an alarm device and an alarm method thereof for a vehicle.

### BACKGROUND OF THE INVENTION

Vehicles with priority rights such as fire fighting trucks, ambulances or military police vehicles must quickly arrive at the event scene to deal with the incident as soon as possible. Therefore, various priority vehicles as described above generally are installed with a warning light device and a speaker or the like on the vehicle to generate a warning light or a warning sound, etc., so that the vehicle on the road can be alerted and the priority vehicle can pass first.

However, even the existing priority vehicles are usually provided with a warning light device and a speaker, the driver of a general vehicle on the road may be limited by the angle of view, the shelter or the distance, and the warning light cannot be effectively seen. Further, the driver may not be able to effectively hear the warning sound while listening to music or closing the window of the vehicle. Thus, the general vehicles on the road cannot get effective warnings, and the priority vehicles cannot pass quickly. Therefore, how to more effectively remind the general vehicle to improve the efficiency of the priority vehicle's travel and rescue is an urgent problem to be solved.

### SUMMARY OF THE INVENTION

The present invention provides a vehicle alarm system that allows a general vehicle on a road to be alerted while allowing a priority vehicle to pass quickly.

The present invention further provides a vehicle alarm device that allows a general vehicle on a road to be alerted and while allowing a priority vehicle to pass quickly.

The present invention further provides a vehicle alarm method that allows a general vehicle on a road to be alerted while allowing a priority vehicle to pass quickly.

Other objects and advantages of the present invention will become apparent from the technical features disclosed herein.

To achieve one or a portion or all of the above or other objects, an embodiment of the present invention provides a vehicle alarm system. The vehicle alarm system includes at least one alarm transmitting device and at least one alarm receiving device. The alarm transmitting device is adapted to be disposed in at least one first vehicle. The alarm transmitting device includes a satellite positioning system. The alarm transmitting device generates an alarm signal. The alarm signal includes a destination signal and a vehicle coordinate signal. The satellite positioning system generates the vehicle coordinate signal. The destination signal includes a coordinate of a destination. The first vehicle moves toward the destination. The alarm receiving device is adapted to be disposed in a second vehicle. The alarm receiving device wirelessly receives the alarm signal. The alarm receiving device generates an alert signal according to the alarm signal.

To achieve one or a portion or all of the above or other objects, an embodiment of the present invention provides a vehicle alarm device adapted to be disposed in a second vehicle. Wherein, the alarm receiving device wirelessly receives an alarm signal, the alarm receiving device generates an alert signal according to the alarm signal, at least one alarm transmitting device is respectively disposed in at least one first vehicle, the alarm transmitting device includes a satellite positioning system, the alarm transmitting device of the first vehicle generates the alarm signal and wirelessly transmits the alarm signal, the alarm signal includes a destination signal and a vehicle coordinate signal, the satellite positioning system generates the vehicle coordinate signal, the destination signal comprises a coordinate of a destination, and the first vehicle moves toward the destination.

To achieve one or a portion or all of the above or other objects, an embodiment of the present invention provides a vehicle alarm method, which includes: an alarm transmitting device disposed in a first vehicle generating an alarm signal; the alarm transmitting device wirelessly transmitting the alarm signal, wherein the alarm signal includes a destination signal and a vehicle coordinate signal, a satellite positioning system of the alarm transmitting device generates the vehicle coordinate signal, the destination signal comprises a coordinate of the destination, and the first vehicle moves toward the destination; an alarm receiving device disposed in a second vehicle wirelessly receiving the alarm signal; and the alarm receiving device generating an alert signal according to the alarm signal.

The vehicle alarm system, the alarm device and the alarm method thereof according to the embodiment of the present invention dispose the alarm receiving device in each of the second vehicles by disposing the alarm transmitting device in each of the first vehicles. The alarm receiving device wirelessly receives an alarm signal transmitted by the first vehicle, wherein the alarm signal includes a vehicle coordinate signal and a destination signal of the first vehicle. The alarm receiving device generates an alert signal according to the alarm signal to remind the driver of the second vehicle. As such, the general vehicle (the second vehicle) on the road can be alerted and the priority vehicle (the first vehicle) can quickly pass.

The above and other objects, features, and advantages of the present invention will become more apparent from the description of the preferred embodiments and the accompanying drawings.

### BRIEF DESCRIPTION OF THE DRAWINGS

FIG. 1 is a schematic view of a vehicle alarm system according to an embodiment of the present invention;

FIG. 2 is a schematic functional block diagram of a vehicle alarm system according to an embodiment of the present invention;

FIG. 3 is a schematic view of a vehicle alarm system according to another embodiment of the present invention; and

FIG. 4 is a flowchart of a vehicle alarm method according to an embodiment of the present invention.

### DETAILED DESCRIPTION OF PREFERRED EMBODIMENTS

The above and other technical contents, features and advantages of the present invention will be apparent from the following detailed description of the preferred embodiments. The directional terms mentioned in the following embodiments, such as up, down, left, right, front or back, etc., are only directions referring to the additional drawings. Therefore, the directional terminology used is for the purpose of illustration and not limitation.

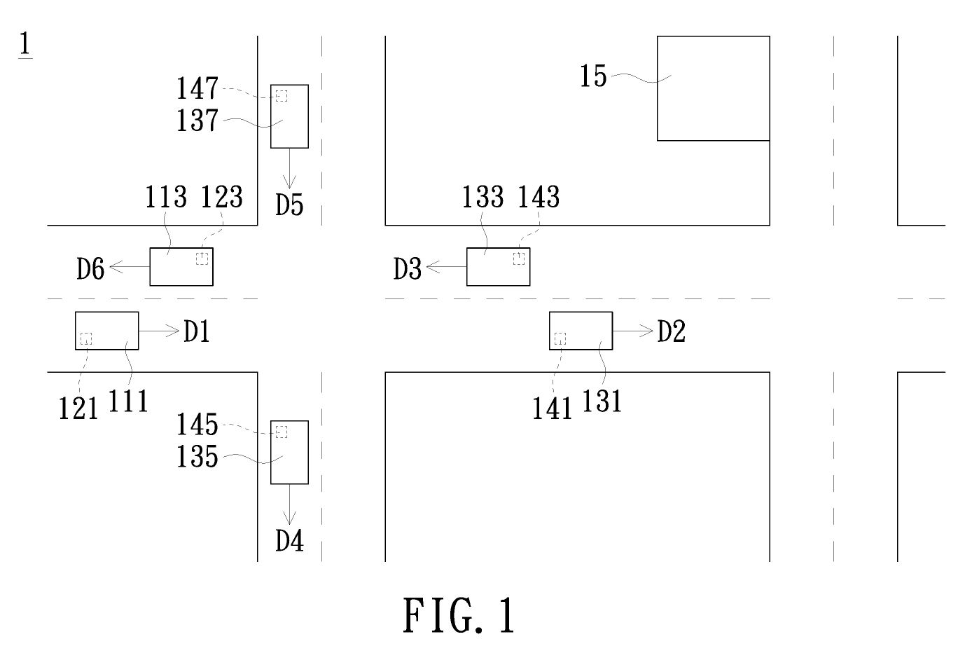

FIG. 1 is a schematic view of a vehicle alarm system according to an embodiment of the present invention, wherein FIG. 1 illustrates the vehicle alarm system of the present invention with traffic conditions on a section of a road. As shown in FIG. 1, the vehicle alarm system 1 includes first vehicles 111 and 113, and second vehicles 131, 133, 135 and 137. The first vehicles 111 and 113 are respectively provided with alarm transmitting devices 121 and 123. The second vehicles 131, 133, 135 and 137 are respectively provided with alarm receiving devices 141, 143, 145 and 147. The traveling directions of the first vehicles 111 and 113 are directions D1 and D6, respectively. The traveling directions of the second vehicles 131, 133, 135 and 137 are D2, D3, D4 and D5, respectively.

In the present embodiment, the first vehicles 111 and 113 may be, for example, priority vehicles such as an ambulance, a fire fighting truck or a police car, and the first vehicle 111 is exemplified as being rushing to the destination 15. The destination 15 may be, for example, an accident location such as a car accident, a fire, or a crime scene. The first vehicle 111 may wirelessly transmit an alarm signal (not shown in FIG. 1) including the coordinates of the destination 15 and the coordinates of the first vehicle 111 itself. The alarm receiving devices 141, 143, 145 and 147 of the respective second vehicles 131, 133, 135 and 137 may respectively receive the alarm signals from the first vehicle 111. The alarm receiving device 141, 143, 145 and 147 may determine whether each of the second vehicles 131, 133, 135 and 137 is on the moving path of the first vehicle 111 according to the coordinate of the first vehicle 111 and the coordinate of the destination 15 in the alarm signal. If YES, the alarm receiving devices 141, 143, 145 and 147 may generate an alert signal (not shown in FIG. 1) to alert the second vehicles 131, 133, 135 and 137, so that the first vehicle 111 can quickly pass to the destination 15. The specific operational details will be described in detail below.

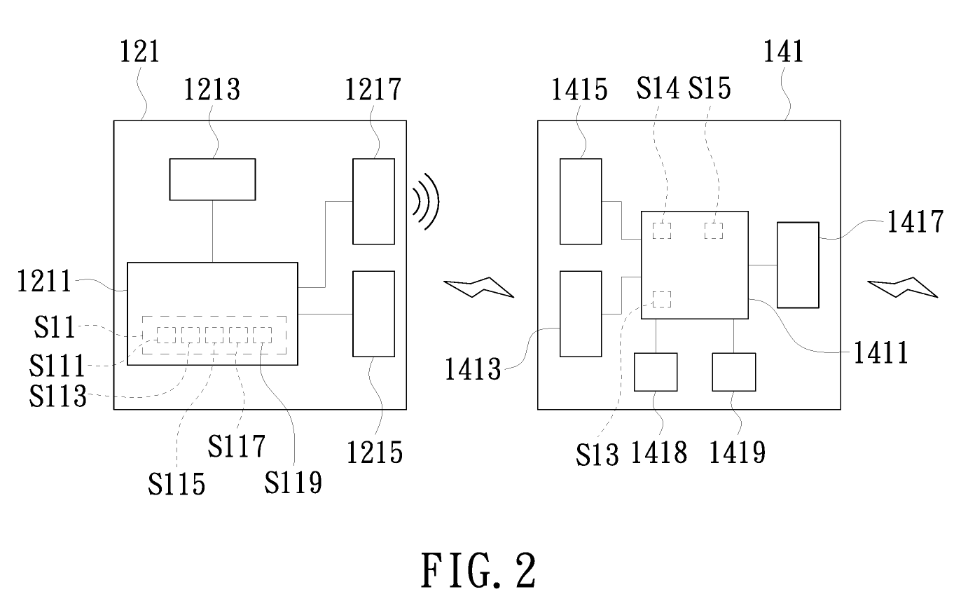

Please refer to FIGS. 1 and 2 both. FIG. 2 is a schematic functional block diagram of a vehicle alarm system according to an embodiment of the present invention, wherein FIG. 2 is exemplified by a functional block diagram of the alarm transmitting device 121 of the first vehicle 111 and is exemplified by a functional block diagram of the alarm receiving device 141 of the second vehicle 131 of the vehicle alarm system 1 shown in FIG. 1. The structure and function of the alarm transmitting device 123 are similar to those of the alarm transmitting device 121, the structure and function of the alarm receiving devices 143, 145 and 147 are similar to those of the alarm receiving device 141, and no redundant detail is to be given herein.

The alarm transmitting device 121 of the first vehicle 111 includes a satellite positioning system 1213. The alarm transmitting device 121 of the first vehicle 111 may generate an alarm signal S11 and wirelessly transmit the alarm signal S11. The alarm signal S11 includes a destination signal S111 and a vehicle coordinate signal S113, wherein the satellite positioning system 1213 generates the vehicle coordinate signal S113 including the coordinate of the location of the first vehicle 111. The destination signal S111 includes the coordinates of the destination 15 shown in FIG. 1, and the first vehicle 111 moves toward the destination 15. Wherein, the destination signal S111 including the coordinates of the accident scene may be input to the alarm transmitting device 121 by, for example, a user and/or a management system (not shown), but the present invention does not limit the input or input mean of the destination signal S111. For example, if the first vehicle 111 is a fire fighting truck and the destination 15 is a fire scene, the user (for example, the driver of the first vehicle 111) may input the coordinates of the destination 15 of the fire scene to the alarm transmitting device 121 by himself or herself. As another example, the fire management system may automatically input the coordinates of the destination 15 to the alarm transmitting device 121. The satellite positioning system 1213 may be, for example, a global positioning system (GPS), a GLONASS system, or a Beidou satellite navigation system (BDS), but the invention is not limited thereto. The vehicle coordinate signal S113 generated by the satellite positioning system 1213 includes the coordinate of the current position of the first vehicle 111.

The second vehicle 131 is disposed with an alarm receiving device 141. The alarm receiving device 141 of the second vehicle 131 may wirelessly receive the alarm signal S11 transmitted by the first vehicle 111. The alarm receiving device 141 may generate an alert signal S13 according to the alarm signal S11. Since the alarm signal S11 includes the destination signal S111 and the vehicle coordinate signal S113, the alarm receiving device 141 may obtain the information of the location of the first vehicle 111 from the vehicle coordinate signal S113. Since the position where the first vehicle 111 moving toward the destination 15 is constantly changing, the alarm receiving device 141 may calculate the change of the vehicle coordinate signal S113 to obtain information such as the moving direction and the vehicle speed of the first vehicle 111. Wherein, it is a common technique to calculate the vehicle speed and the vehicle moving direction through the vehicle coordinate signal of the satellite positioning system, and no redundant detail is to be given herein.

Therefore, the alarm receiving device 141 may obtain information such as the position, the moving direction, the vehicle speed, and the coordinates of the destination 15 to be reached of the first vehicle 111 from the alarm signal S11. The alarm receiving device 141 may accordingly determine whether the second vehicle 131 is on the moving path of the first vehicle 111. If YES, the alarm receiving device 141 may generate the alert signal S13 to warn the driver of the second vehicle 131 to let the driver know that he or she is on the moving path of the first vehicle 111. The alerting signal S13 may further include, for example, distance information of the first vehicle 111 from the second vehicle 131, or time information for estimating the first vehicle 111 to reach the second vehicle 131, etc., so that the driver of the second vehicle 131 can grasp the state of the first vehicle 111 and appropriately perform actions such as pulling over or bypass, and therefore the first vehicle 111 can quickly reach the destination 15. Wherein, the means for determining whether the second vehicle 131 is on the moving path of the first vehicle 111, calculating the relative distance between the two vehicles, or estimating the arrival time of the first vehicle 111 by the information such as the position, the moving direction and the vehicle speed of the first vehicle 111 are a common technique, and no redundant detail is to be given herein.

As shown in FIG. 1, similarly, the alarm receiving devices 143, 145 and 147 of the second vehicles 133, 135 and 137 may receive the alarm signal S11 and determine whether the second vehicles 133, 135 and 137 are on the moving path of the first vehicle 111. The alarm receiving devices 143, 145 and 147 may generate corresponding alert signals so that the first vehicle 111 can quickly reach the destination 15. It should be noted that the alarm receiving devices 141, 143, 145 and 147 of the second vehicles 131, 133, 135 and 137 can more accurately determine the moving path of the first vehicle 111 according to the destination signal S111 included in the alarm signal S11. For example, in the example of FIG. 1, the first vehicle 111 moves toward the direction D1 (to the right of FIG. 1) to the destination 15, the second vehicle 131 moves toward the direction D2 (to the right of FIG. 1), and the first vehicle 111 is located behind the second vehicle 131. The alarm receiving device 141 of the second vehicle 131 may obtain the position coordinate of the destination 15 according to the destination signal S111. Therefore, the alert signal S13 generated by the alarm receiving device 141 may include, for example, a driving advise asking the driver of the second vehicle 131 to turn right at the front intersection, go straight at the front intersection, pull over to leave the lane, or not turn left at the front intersection, so that the first vehicle 111 can quickly reach the destination 15.

Similarly, when the second vehicle 133 moves toward the direction D3, the alarm receiving device 143 may obtain information such as the position, the moving direction, the vehicle speed, and the coordinates of the destination 15 of the first vehicle 111 according to the alarm signal S11, and generate an alert signal to remind the driver to perform the driving advice such as pulling over or turning right at the front intersection. When the second vehicle 135 moves toward the direction D4, the alarm receiving device 145 may generate an alert signal according to the alarm signal S to remind the driver, for example, not to make a u-turn. Since the second vehicle 135 is not on the travel path of the first vehicle 111, the alarm receiving device 145 may not generate an alert signal. When the second vehicle 137 moves toward the direction D5, the alarm receiving device 147 may generate an alert signal according to the alarm signal S11 to remind the driver, for example, to slow down the speed or to stop.

Incidentally, the alarm receiving device 141 may further include, for example, a satellite positioning system and/or map information (not shown) to perform determination of whether the second vehicle 131 is on the moving path of the first vehicle 111 or calculation of relative distance, etc., but the invention is not limited thereto. The alarm receiving device of each of the second vehicles 131, 133, 135 and 137 generates a corresponding alert signal after obtaining information such as the position, the moving direction, the vehicle speed and the coordinates of the destination 15 to be reached of the first vehicle 111, so as to avoid collision between each of the second vehicles 131, 133, 135, 137 and the first vehicle 111, wherein the manner in which each of the second vehicles 131, 133, 135 and 137 collides with the first vehicle 111 is avoided, for example, by using a commonly used navigation operation means, and the technical details thereof are not described in detail herein. The alarm receiving device 141 may be disposed, for example, on an electronic device such as a car satellite navigation device, a mobile phone, a tablet computer, or a car computer, and the alarm receiving device 141 may be disposed inside the electronic device; the alarm receiving device 141 may also be connected to these electronic devices, for example, in an external manner., and the alarm receiving device 141 may be, for example, disposed on a vehicle body (not shown) of the second vehicle 131; and the invention is not limited thereto.

Similarly, the first vehicle 113 traveling toward the direction D6 is also a priority vehicle such as an ambulance, a fire fighting truck or a police car. The alarm transmitting device 123 of the first vehicle 113 may generate an alarm signal (not shown). The alarm receiving device of each of the second vehicles 131, 133, 135 and 137 may receive the alarm signal sent by the first vehicle 113 to obtain information such as the position, the moving direction D6, the vehicle speed, and the coordinates of the destination to be reached of the first vehicle 113, and generate a corresponding alert signal to remind the driver. Therefore, the vehicle alarm system of the present invention can set alarm receiving devices in general vehicles in a decentralized manner, so that each first vehicle (priority vehicle) can quickly reach the destination, and the vehicle at the event site can be alerted without the need for a central traffic alert management center. As such, the cost of building a vehicle alarm system can be significantly reduced, and the efficiency of allowing priority vehicles to reach their destinations quickly can be improved.

As shown in FIG. 2, the alarm receiving device 141 disposed in the second vehicle 131 may include a processor 1411 and a wireless receiver 1413. The wireless receiver 1413 is coupled to the processor 1411. The wireless receiver 1413 may wirelessly receive the alarm signal S11. When the wireless receiver 1413 receives the alarm signal S11 from the same first vehicle 111 at least twice, the processor 1411 may generate a moving direction signal S14 related to the moving direction of the first vehicle 111 and a speed signal S15 related to the moving speed of the first vehicle 111 according to the change of the vehicle coordinate signal S113. The processor 1411 may generate the alert signal S13 according to the vehicle coordinate signal S113, the moving direction signal S14, the speed signal S15 and the destination signal S111 to alert the driver of the second vehicle 131 so that the first vehicle 111 can quickly reach the destination 15.

Further, the alarm transmitting device 121 of the first vehicle 111 further includes a wireless transmitter 1215. The alarm transmitting device 121 transmits the alarm signal S11 through the wireless transmitter 1215 wirelessly. The alarm transmitting device 121 may further include, for example, a processor 1211, and the processor 1211 is coupled to the satellite positioning system 1213 and the wireless transmitter 1215. The processor 1211 may perform the generation and transmission of the above-mentioned alarm signal S11. The processor 1211 of the alarm transmitting device 121 and the processor 1411 of the alarm receiving device 141 may be implemented, for example, by electronic components such as logic circuits, and the wireless transmitter 1215 of the alarm transmitting device 121 and the wireless receiver 1413 of the alarm receiving device 141 may be implemented, for example, by various possible radio wave transceivers, but the invention is not limited thereto.

Incidentally, the alarm receiving device 141 of the second vehicle 131 may further include a wireless transmitter 1417. The processor 1411 may determine whether the second vehicle 131 is on the moving path of the first vehicle 111 according to the destination signal S111 and the moving direction signal S14. If the determination result of the processor 1411 is YES, the alarm receiving device 141 may also transmit the alarm signal S11 through the wireless transmitter 1417 wirelessly. Each of the second vehicles 131, 133, 135 and 137 wirelessly transmitting the received alarm signal S11 can achieve the purpose of forwarding the alarm signal S11, so that more other vehicles may receive the alarm signal S11 without being limited by the signal transmission range of the alarm transmitting device 121 of the first vehicle 111. The second vehicle 131 may forward the alarm signal S11 only when the second vehicle 131 is on the moving path of the first vehicle 111. When the second vehicle 131 is not on the moving path of the first vehicle 111, the alarm signal S11 may not be forwarded to reduce the burden of the vehicle alarm system 1. However, in other embodiments of the present invention, the second vehicle 131 may also directly forward the alarm signal S11 without making other determinations.

Further, the processor 1411 of the alarm receiving device 141 determines whether the second vehicle 131 is on the moving path of the first vehicle 111 according to the destination signal S111 and the moving direction signal S14. If the determination result of the processor 1411 is YES, the alarm receiving device 141 generates the alert signal S13 according to the alarm signal S11. If the determination result of the processor 1411 is NO, the alarm receiving device 141 does not generate the alert signal S13. Therefore, the vehicle alarm system 1 may generate the alert signal S13 to remind the driver only when the second vehicle 131 is on the moving path of the first vehicle 111. In other embodiments of the present invention, the alarm receiving device 141 generates the alert signal S13 according to the alarm signal S11 regardless of whether the second vehicle 131 is on the moving path of the first vehicle 111, so that the driver can know the status of the nearby priority vehicle.

Further, the alarm receiving device 141 may include, for example, a display 1418, and the display 1418 is coupled to the processor 1411. The alert signal S13 may include, for example, an image signal (not shown), and the alarm receiving device 141 may display the message included in the alert signal S13 through the display 1418 to alert the driver. The alarm receiving device 141 may include, for example, a speaker 1419, and the speaker 1419 is coupled to the processor 1411. The alert signal S13 may include, for example, a sound signal (not shown), and the alarm receiving device 141 may send a sound of the message included in the alert signal S13 through the speaker 1419 to alert the driver. The arrangement of the display 1418 and/or the speaker 1419 is only one possible embodiment for alerting the driver by the alert signal S13, and is not intended to limit the invention. The arrangement of the alarm receiving device 141 configured to alert the driver is within the scope of the present invention as long as it is based on the alert signal S13.

On the other hand, the alarm transmitting device 121 of the first vehicle 111 may further include, for example, a speaker 1217, and the alarm signal S11 further includes a sound signal S115. The alarm transmitting device 121 may transmit the sound signal S115 through the speaker 1217. The alarm receiving device 141 of the second vehicle 131 further includes a sound receiver 1415. The sound receiver 1415 may receive the sound signal S115, and the alarm receiving device 141 may also generate the alert signal S13 according to the sound signal S115. The sound receiver 1415 may be implemented, for example, by a microphone device, but the invention is not limited thereto. The first vehicle 111 may also send an alert message (sound signal S115) through the speaker 1217, and the second vehicle 131 may receive the alert message sent by the first vehicle 111 through the sound receiver 1415, and accordingly generate the alert signal S13 to remind the driver, so as to prevent the driver from not hearing the sound signal S115 from the first vehicle 111 due to listening to music, closing windows or noisy environments.

Further, in an embodiment, the sound receiver 1415 of the alarm receiving device 141 is coupled to the processor 1411. The processor 1411 may generate the alert signal S13 according to, for example, a change in the sound frequency of the sound signal S115. For example, when the sound frequency of the sound signal S115 is higher, it may indicate that the first vehicle 111 is getting closer; conversely, when the sound frequency of the sound signal S115 is lower, it may indicate that the first vehicle 111 is far away. The alarm receiving device 141 may accordingly generate the alert signal S13 to remind the driver to make an appropriate response. In other embodiments of the present invention, the processor 1411 may generate the alert signal S13 according to the volume of the sound signal S115. For example, when the volume of the sound signal S115 is greater, it may indicate that the first vehicle 111 is closer, but the invention is not limited thereto.

The satellite positioning system 1213, the wireless transmitter 1215 and the speaker 1217 of the alarm transmitting device 121 shown in FIG. 2 are exemplified by being disposed inside the alarm transmitting device 121, and the wireless receiver 1413, the sound receiver 1415, the wireless transmitter 1417, the display 1418 and the speaker 1419 of the alarm receiving device 141 are exemplified by being disposed inside the alarm receiving device 141, but the invention is not limited thereto. In a practical application, the satellite positioning system 1213, the wireless transmitter 1215 or the speaker 1217 may be disposed outside the alarm transmitting device 121, and then coupled to the processor 1211 in a wire or wireless manner. The wireless receiver 1413, the sound receiver 1415, the wireless transmitter 1417, the display 1418 and the speaker 1419 may be disposed outside the alarm receiving device 141, and then coupled to the processor 1411 in a wire or wireless manner.

The vehicle alarm system 1 shown in FIG. 1 includes first vehicles 111 and 113. The alarm signals of the first vehicles 111 and 113 may also include a priority signal, respectively. Each priority signal may include a priority level of the respective first vehicles 111 and 113. Taking the first vehicle 111 as an example, the alarm signal S11 may include a priority signal S117, and the alarm receiving device 141 of the second vehicle 131 may also generate the alert signal S13 according to the priority signal S117. The priority signal S117 of the first vehicle 111 includes, for example, a priority level generated according to information of the first vehicle 111 and/or information of the destination. The function and principle of the priority signal (not shown) of the first vehicle 113 are similar to those of the priority signal S117 of the first vehicle 111, and no redundant detail is to be given herein. For example, the first vehicle 111 is a police car and the destination 15 is a drink dispute site; and the first vehicle 113 is an ambulance and its destination is a scene of a seriously-injured patient to be rescued. At this time, the priority level included in the priority signal of the first vehicle 113 may be set to be higher than the priority level included in the priority signal S117 of the first vehicle 111. The alarm receiving devices 141, 143, 145 and 147 of the second vehicles 131, 133, 135 and 137 may generate the alert signals according to the priority signal S117 of the first vehicle 111 and the priority signal of the first vehicle 113, so that the first vehicle with a higher priority signal level (i.e., the priority signal includes a higher priority level) can pass preferentially. The priority level of each of the first vehicles 111 and 113 may be set by a person according to regulations or experience, for example, and may be set by a computer system according to preset parameters, etc., and the invention is not limited thereto.

Incidentally, in an embodiment of the present invention, the priority levels of the priority signals of the first vehicles 111 and 113 are not always fixed. The priority levels of the first vehicles 111 and 113 may be set by the personnel according to regulations or experience or may be set by the computer system according to preset parameters at the time of each mission attendance, but the invention is not limited thereto.

Further, the alarm signals of the first vehicles 111 and 113 may further include an identification signal. Each identification signal may include information of the respective first vehicles 111 and 113. Taking the first vehicle 111 as an example, the alarm signal S11 may include an identification signal S119, and the alarm receiving device 141 of the second vehicle 131 may generate the alert signal S13 according to the identification signal S119. The identification signal S119 may include, for example, encoded data, and the identification signal S119 of the first vehicle 111 and the identification signal (not shown) of the first vehicle 113 are different coded data. The alarm receiving device 141 may distinguish the first vehicles 111 and 113 based on these identification signals, for example, so that the vehicle alarm system 1 can more fully allow the first vehicles 111 and 113 to reach their destinations.

For example, when the second vehicle 131 receives the alarm signal S11, the second vehicle 131 may determine whether the alarm signal S11 needs to be processed through the identification signal S119 due to that the alarm signal S11 received by the second vehicle 131 may be transmitted by the first vehicle 111 or may be forwarded by other second vehicles (for example, the second vehicle 133). When the second vehicle 131 calculates the alarm signal S11 received at different time points, it can perform the calculation or determination of the alert signal S13, the moving direction signal S14, and the speed signal S15 after it is determined by the identification signal S119 that the received alarm signals S11 are all from the same vehicle.

It should be noted that the levels of the priority signals of the first vehicles may be the same, but the encoded data of the identification signals of the first vehicles are different, so that the alarm receiving device 141 can distinguish the first vehicles according to the identification signals. For example, the first vehicles 111 and 113 both are fire fighting trucks, and their destinations are the same fire scene. At this time, the levels of the priority signals of the first vehicles 111 and 113 may be the same, but the encoded data of their identification signals are different.

The vehicle alarm system 1 shown in FIGS. 1 and 2 is exemplified by two first vehicles 111 and 113, four second vehicles 131, 133, 135 and 137 and one destination 15, but the present invention does not limit the number of first vehicles, second vehicles and destinations.

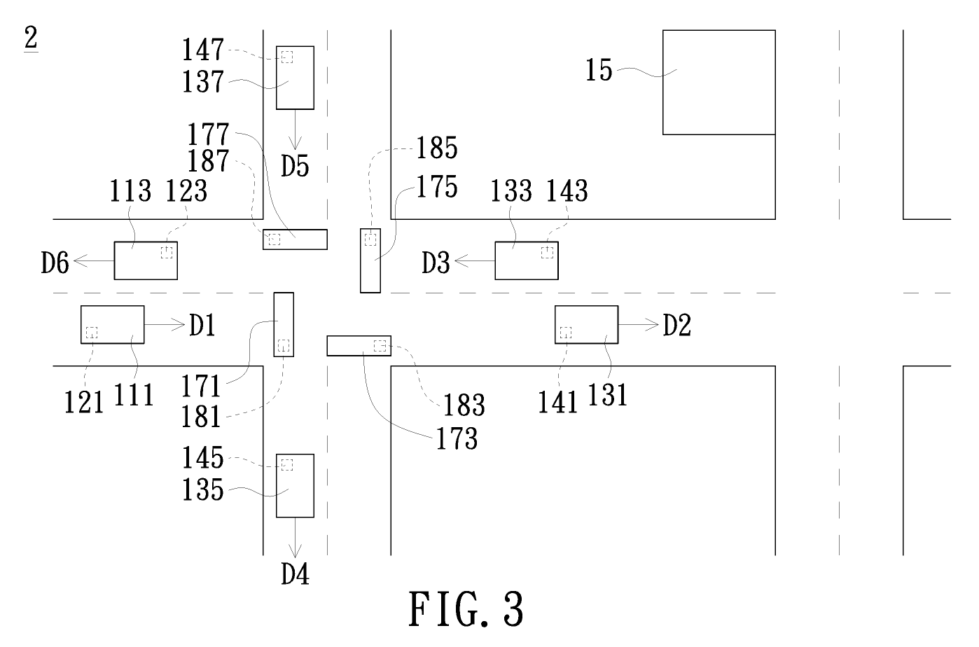

Please refer to FIG. 3. FIG. 3 is a schematic view of a vehicle alarm system according to another embodiment of the present invention. The vehicle alarm system 2 of the present embodiment has a similar structure and function to the vehicle alarm system 1 shown in FIG. 1. The difference between this embodiment and the embodiment shown in FIG. 1 mainly lies in that: in the vehicle alarm system 2, the alarm receiving devices 181, 183, 185 and 187 are respectively disposed in the traffic signal devices 171, 173, 175 and 177, and the structures and functions of the alarm receiving devices 181, 183, 185 and 187 are similar to those of the alarm receiving device 141 shown in FIGS. 1 and 2. The alarm receiving devices 181, 173, 185 and 187 of the traffic sign devices 171, 173, 175 and 177 wirelessly receive the alarm signals transmitted by the first vehicles 111 and 113. The traffic sign devices 171, 173, 175 and 177 generate traffic alert signals (not shown) according to the alarm signals to guide the second vehicles 131, 133, 135 and 137, so that the second vehicles 131, 133, 135 and 137 may not collide with the first vehicles 111 and 113, and thereby allowing the first vehicles 111 and 113 to quickly reach their destinations. The traffic alert signals generated by the traffic signal devices 171, 173, 175 and 177 may be, for example, lights, animations and/or characters of different colors, and the invention is not limited thereto. The traffic sign devices 171, 173, 175 and 177 may be implemented, for example, by traffic control devices such as traffic lights, and the traffic signage devices 171, 173, 175 and 177 may generate a traffic alert signal in a manner similar to the embodiment shown in FIG. 1 to FIG. 2 in which the alert signal S13 is generated, and no redundant detail is to be given herein.

For example, in the example of FIG. 3, the first vehicle 111 is toward the direction D1 to the destination 15. The traffic signal device 171 may generate a traffic alert signal according to the alarm signal S11 transmitted by the first vehicle 111 to guide each vehicle to pull over. The traffic sign device 173 may generate a traffic alert signal to guide each vehicle to stop. The traffic signal device 175 may generate a traffic alert signal to guide each vehicle to pull over or not have a left turn. The traffic sign device 177 may generate a traffic alert signal to guide each vehicle to stop. Thus, the first vehicle 111 can quickly reach the destination 15.

It is to be noted that the vehicle alarm system 1 shown in FIGS. 1 and 2 is exemplified by that the alarm receiving devices 141, 143, 145 and 147 are disposed in the respective second vehicles 131, 133, 135 and 137. The vehicle alarm system 2 shown in FIG. 3 is exemplified by that the alarm receiving devices 181, 183, 185 and 187 are disposed in the respective traffic signal devices 171, 173, 175 and 177. However, the present invention does not exclude that the alarm receiving device may be disposed elsewhere, and the user can obtain the alert message to facilitate the quick passage of the first vehicles 111 and 113 (priority vehicles). For example, the alarm receiving device may be disposed in various electronic devices such as a mobile phone, a tablet computer or a navigation device. Pedestrians, traffic commanders, motorcycle riders, and drivers who use these electronic products can receive the alarm signals from the first vehicles 111 and 113, and can receive corresponding alerts.

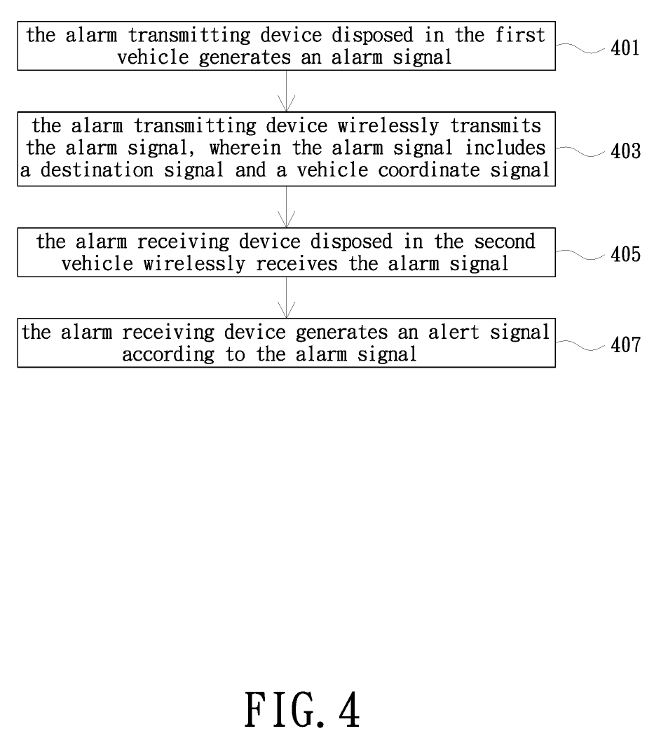

Please refer to FIG. 4. FIG. 4 is a flowchart of a vehicle alarm method according to an embodiment of the present invention. Please also refer to FIGS. 1 and 2. In step 401, the alarm transmitting device 121 disposed in the first vehicle 111 generates an alarm signal S11. Thereafter, in step 403, the alarm transmitting device 121 wirelessly transmits the alarm signal S11, wherein the alarm signal S11 includes a destination signal S111 and a vehicle coordinate signal S113. The satellite positioning system 1213 of the alarm transmitting device 121 generates the vehicle coordinate signal S113. The destination signal S111 includes the coordinates of the destination 15. The first vehicle 111 moves toward the destination 15. In step 405, the alarm receiving device 141 disposed in the second vehicle 131 wirelessly receives the alarm signal S11. Thereafter, in step 407, the alarm receiving device 141 generates an alert signal S13 according to the alarm signal S11.

Further, the vehicle alarm method of the embodiment of the present invention can be sufficiently taught, suggested, and implemented by the description of the embodiment of FIGS. 1 and 2, and no redundant detail is to be given herein.

In summary, the vehicle alarm system, the alarm device and the alarm method thereof according to the embodiment of the present invention dispose the alarm receiving device in each of the second vehicles by disposing the alarm transmitting device in each of the first vehicles. The alarm receiving device wirelessly receives an alarm signal transmitted by the first vehicle, wherein the alarm signal includes a vehicle coordinate signal and a destination signal of the first vehicle. The alarm receiving device generates an alert signal according to the alarm signal to remind the driver of the second vehicle. As such, the general vehicle (the second vehicle) on the road can be alerted and the priority vehicle (the first vehicle) can quickly pass. The vehicle alarm system of the present invention can set alarm receiving devices in general vehicles in a decentralized manner, so that each first vehicle (priority vehicle) can quickly reach the destination, and the vehicle at the event site can be alerted without the need for a central traffic alert management center. As such, the cost of building a vehicle alarm system can be significantly reduced, and the efficiency of allowing priority vehicles to reach their destinations quickly can be improved.

Although the present invention has been disclosed in the above embodiments, it is not intended to limit the present invention, and those skilled in the art can make some modifications and refinements without departing from the spirit and scope of the present invention. Therefore, the scope of the invention is defined by the scope of the appended claims.

What is claimed is:

1. A vehicle alarm system, comprising:
at least one alarm transmitting device, wherein the alarm transmitting device is adapted to be disposed in at least one first vehicle, the alarm transmitting device comprises a satellite positioning system, the alarm transmitting device generates an alarm signal, the alarm signal comprises a destination signal and a vehicle coordinate signal, the satellite positioning system generates the vehicle coordinate signal, the destination signal comprises a coordinate of a destination, and the first vehicle moves toward the destination; and
at least one alarm receiving device, wherein the alarm receiving device is adapted to be disposed in a second vehicle, the alarm receiving device wirelessly receives the alarm signal, and the alarm receiving device generates an alert signal according to the alarm signal.

2. The vehicle alarm system according to claim 1, wherein the alarm receiving device comprises a processor and a wireless receiver, the wireless receiver is coupled to the processor, wherein when the wireless receiver receives the alarm signal from the same first vehicle at least twice, the processor generates a moving direction signal related to a moving direction of the first vehicle and a speed signal related to a moving speed of the first vehicle according to a change of the vehicle coordinate signal, and the processor generates the alert signal according to the moving direction signal, the speed signal and the destination signal.

3. The vehicle alarm system according to claim 1, wherein the alarm transmitting device further comprises a wireless transmitter, and the alarm transmitting device wirelessly transmits the alarm signal through the wireless transmitter.

4. The vehicle alarm system according to claim 2, wherein the alarm receiving device further comprises a wireless transmitter, the processor determines whether the second vehicle is on a moving path of the first vehicle according to the destination signal and the moving direction signal, and if YES, the alarm receiving device transmits the alarm signal wirelessly through the wireless transmitter.

5. The vehicle alarm system according to claim 2, wherein the processor determines whether the second vehicle is on a moving path of the first vehicle according to the destination signal and the moving direction signal, if YES, the alarm receiving device generates the alert signal according to the alarm signal, and if NO, the alarm receiving device does not generate the alert signal.

6. The vehicle alarm system according to claim 1, wherein the alarm transmitting device further comprises a speaker, the alarm transmitting device transmits a sound signal through the speaker, the alarm receiving device further comprises a sound receiver, the sound receiver receives the sound signal, and the alarm receiving device further generates the alert signal according to the sound signal.

7. The vehicle alarm system according to claim 6, wherein the alarm receiving device disposed in the second vehicle further comprises a processor, the sound receiver is coupled to the processor, and the processor generates the alert signal according to a change in a sound frequency of the sound signal.

8. The vehicle alarm system according to claim 1, wherein the vehicle alarm system comprises a plurality of alarm transmitting devices, the alarm transmitting devices are adapted to be disposed in a plurality of the first vehicles, each of the alarm signals generated by each of the alarm transmitting devices comprises a priority signal, each of the priority signals comprises a priority level of each of the first vehicles, and the alarm receiving device generates the alert signal according to the priority signals.

9. The vehicle alarm system according to claim 1, wherein the vehicle alarm system comprises a plurality of alarm transmitting devices, the alarm transmitting devices are adapted to be disposed in a plurality of the first vehicles, each of the alarm signals generated by each of the alarm transmitting devices comprises an identification signal, each of the identification signals comprises information of each of the first vehicles, and the alarm receiving device generates the alert signal according to the identification signals.

10. The vehicle alarm system according to claim 1, wherein the alarm receiving device is adapted to be disposed in at least one traffic signal device, the alarm receiving device of the traffic signal device wirelessly receives the alarm signal, and the traffic signal device generates a traffic alert signal according to the alarm signal.

11. An alarm receiving device, adapted to be disposed in a second vehicle;
wherein the alarm receiving device wirelessly receives an alarm signal, the alarm receiving device generates an alert signal according to the alarm signal, at least one alarm transmitting device is respectively disposed in at least one first vehicle, the alarm transmitting device comprises a satellite positioning system, the alarm transmitting device of the first vehicle generates the alarm signal and wirelessly transmits the alarm signal, the alarm signal comprises a destination signal and a vehicle coordinate signal, the satellite positioning system generates the vehicle coordinate signal, the destination signal comprises a coordinate of a destination, and the first vehicle moves toward the destination.

12. A vehicle alarm method, comprising:
an alarm transmitting device disposed in a first vehicle generating an alarm signal;
the alarm transmitting device wirelessly transmitting the alarm signal, wherein the alarm signal comprises a destination signal and a vehicle coordinate signal, a satellite positioning system of the alarm transmitting device generates the vehicle coordinate signal, the destination signal comprises a coordinate of the destination, and the first vehicle moves toward the destination;
an alarm receiving device disposed in a second vehicle wirelessly receiving the alarm signal; and
the alarm receiving device generating an alert signal according to the alarm signal.

13. The vehicle alarm method according to claim 12, wherein the alarm receiving device comprises a processor and a wireless receiver, the wireless receiver is coupled to the processor, and the vehicle alarm method further comprises:
when the wireless receiver receives the alarm signal from the same first vehicle at least twice, the processor generating a moving direction signal related to the moving direction of the first vehicle and a speed signal related to the moving speed of the first vehicle according to a change of the vehicle coordinate signal; and
the processor generating the alert signal according to the moving direction signal, the speed signal and the destination signal.

14. The vehicle alarm method according to claim 13, wherein the alarm receiving device further comprises a wireless transmitter, and the vehicle alarm method further comprises:
the processor determining whether the second vehicle is on a moving path of the first vehicle according to the destination signal and the moving direction signal, and if YES, the alarm receiving device transmitting the alarm signal wirelessly through the wireless transmitter.

15. The vehicle alarm method according to claim 13, further comprising:
the processor determining whether the second vehicle is on a moving path of the first vehicle according to the destination signal and the moving direction signal, if YES, the alarm receiving device generating the alert signal according to the alarm signal, and if NO, the alarm receiving device not generating the alert signal.

16. The vehicle alarm method according to claim 12, wherein the vehicle alarm system comprises a plurality of alarm transmitting devices, the alarm transmitting devices are adapted to be disposed in a plurality of the first vehicles, each of the alarm signals generated by each of the alarm transmitting devices comprises a priority signal, each of the priority signals comprises a priority level of each of the first vehicles, and the vehicle alarm method further comprises:
the alarm receiving device generating the alert signal according to the priority signals.

17. The vehicle alarm method according to claim 12, wherein the vehicle alarm system comprises a plurality of alarm transmitting devices, the alarm transmitting devices are adapted to be disposed in a plurality of the first vehicles, each of the alarm signals generated by each of the alarm transmitting devices comprises an identification signal, each of the identification signals comprises information of each of the first vehicles, and the vehicle alarm method further comprises:
the alarm receiving device generating the alert signal according to the identification signals.
